(19) United States
(12) Patent Application Publication
(10) Pub. No.: US 2026/0352014 A1
(43) Pub. Date: Nov. 5, 2026

(54) CIRCUIT BREAKER, POWER DISTRIBUTION BOX, AND HOUSEHOLD POWER DISTRIBUTION NETWORK

(71) Applicant: SHENZHEN HELLO TECH ENERGY CO., LTD, Shenzhen (CN)

(72) Inventors: Gaosong SHEN, Shenzhen (CN); Feiyan LUO, Shenzhen (CN); Ke WU, Shenzhen (CN)

(21) Appl. No.: 19/726,887

(22) Filed: Jun. 30, 2026

Related U.S. Application Data
(63) Continuation of application No. PCT/CN2025/132847, filed on Nov. 5, 2025.

(30) Foreign Application Priority Data
May 26, 2025 (CN) 20510687465.7
May 26, 2025 (CN) 202510687469.5
May 26, 2025 (CN) 202510690051.X

(51) Int. Cl. H02J 9/06; H02J 13/183; H02J 13/34; H02J 105/12

(52) U.S. Cl. CPC H02J 9/062; H02J 9/068; H02J 13/183; H02J 13/34; H02J 2105/12

(57) ABSTRACT

Provided are a circuit breaker, a power distribution box, and a household power distribution network. The network includes a first AC power supply, an energy storage device, and a plurality of load branches connected in parallel, at least one load branch is connected to the energy storage device. The circuit breaker includes: a switch having a first terminal connected to the first AC power supply and a second terminal connected to the load branches; a communication module communicating with the energy storage device; a detection module configured to detect whether the first terminal of the switch is de-energized and to generate a first detection signal; and a control module capable of controlling the switch to be turned on. The circuit breaker is normally opened and communicates with the energy storage device to allow the energy storage device to supply power to the other load branches.

### CROSS-REFERENCE TO RELATED APPLICATION

This application is a continuation of International Application No. PCT/CN2025/132847 filed on Nov. 5, 2025, which claims priorities to and benefits of Chinese patent application Nos. 202510687465.7, 202510687469.5, and 202510690051.X, filed with China National Intellectual Property Administration on May 26, 2025, the entire contents of which are incorporated herein by reference.

### FIELD

The present disclosure relates to the field of household power distribution technologies, and more particularly, to a circuit breaker, a distribution box, and a household power distribution network.

### BACKGROUND

In a conventional household power distribution network, the mains power is connected to a household power distribution box, which supplies power to the household loads through various power supply branches. However, such a conventional household power distribution network can only be supplied with power by the mains power. If the mains power is de-energized, all household loads are powered off.

To address the issue of household loads being powered off when the mains power is de-energized, a standby energy storage power supply can be adopted in existing solutions. There are mainly two approaches for connecting the standby energy storage power supply. First, a smart power distribution box is equipped for core household loads or a traditional power distribution box is replaced with a smart power distribution box. The smart power distribution box can be connected to the mains power or the standby energy storage power supply. It has a plurality of power supply branches formed internally to supply power to household loads, and automatically switches to the standby energy storage power supply when the mains power is de-energized. Second, an Automatic Transfer Switch (ATS) is mounted upstream of the traditional power distribution box. The ATS can be connected to the mains power or the standby energy storage power supply and has a function of switching between the mains power and the standby energy storage power supply. However, on and off states of the power supply branches for household loads still need to be manually controlled through the traditional power distribution box. After the mains power is de-energized, the ATS can automatically switch to the standby energy storage power supply for power supply.

In the two above solutions, both the distribution box and the ATS are relatively large in size, occupying a considerable amount of space. In addition, high costs are involved in both the two types of power facilities and their mounting, and professional electricians are required to drill holes, reconnect battery cells, etc. Therefore, there is an urgent need for a flexible power distribution solution that can smoothly connect the standby energy storage power supply when the mains power is de-energized, to ensure the normal operation of household loads while reducing equipment size and mounting costs.

### SUMMARY

The present disclosure aims to solve at least one of the technical problems in the related art. To this end, the present disclosure provides a circuit breaker, a power distribution box, and a household power distribution network. After mains power is de-energized, an energy storage device supplies power to the circuit breaker. The circuit breaker transmits information about a mains power failure and an open state of the circuit breaker to the energy storage device, so that the energy storage device performs inversion to supply power to the load.

In a first aspect, the present disclosure provides a circuit breaker. The household power distribution network includes a first alternating current power supply, an energy storage device, and a plurality of load branches. The plurality of load branches are connected in parallel. At least one of the plurality of load branches is connected to the energy storage device. The circuit breaker includes: a switch having a first terminal configured to be connected to the first alternating current power supply and a second terminal configured to be connected to the plurality of load branches; a communication module configured to communicate with the energy storage device; a detection module connected to the first terminal of the switch and configured to detect whether the first terminal of the switch is de-energized and to generate a first detection signal indicating whether the first alternating current power supply is de-energized; and a control module connected to the detection module and the communication module and capable of controlling the switch to be turned on. When the first alternating current power supply is de-energized, the switch is turned off, and the control module is configured to transmit a first signal to the energy storage device via the communication module, to allow the energy storage device to supply a second alternating current power supply to other load branches of the plurality of load branches.

In a second aspect, the present disclosure provides a power distribution box including a circuit breaker.

In a third aspect, the present disclosure provides a household power distribution network including the power distribution box, the energy storage device, and the plurality of load branches.

Embodiments of the present disclosure provide a circuit breaker, a power distribution box, and a household power distribution network. The household power distribution network includes the first alternating current power supply, the energy storage device, and the plurality of load branches. The plurality of load branches are connected in parallel, and at least one of the plurality of load branches is connected to the energy storage device. The circuit breaker includes the switch, the communication module, the detection module, and the control module. When the first alternating current power supply (such as the mains power) is de-energized, the energy storage device on a load side can provide the second alternating current power supply to supply power to the detection module, the communication module, and the control module through the power supply module. The detection module detects that the first alternating current power supply connected to the first terminal of the switch is de-energized, generates a first detection signal indicating that the first alternating current power supply is de-energized, and transmits the first detection signal to the control module. The switch (a normally open switch) is automatically turned off, or the switch (a non-normally open switch) is driven by a motor under the control of a controller of the control module to be turned off. Subsequently, the control module transmits de-energization information of the first alternating current power supply to the communication module, which then transmits the first signal to the energy storage device. The energy storage device performs inversion to supply the second alternating current power supply to other load branches of the plurality of load branches. In the above process, the second alternating current power supply provided by the energy storage device on the load side enables the circuit breaker to be opened normally when the first alternating current power supply is de-energized, and communication between the energy storage device and the circuit breaker to be restored. In this way, the energy storage device can be controlled to output power via inversion to the load, maintaining safety and stability of the power supply system.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic view showing an application scenario of a circuit breaker according to some embodiments of the present disclosure.

FIG. 2 is a first schematic structural view of a circuit breaker according to some embodiments of the present disclosure.

FIG. 3 is a second schematic structural view of a circuit breaker according to some embodiments of the present disclosure.

FIG. 4 is a third schematic structural view of a circuit breaker according to some embodiments of the present disclosure.

FIG. 5 is a fourth schematic structural view of a circuit breaker according to some embodiments of the present disclosure.

FIG. 6 is a fifth schematic structural view of a circuit breaker according to some embodiments of the present disclosure.

FIG. 7 is a sixth schematic structural view of a circuit breaker according to some embodiments of the present disclosure.

FIG. 8 is a seventh schematic structural view of a circuit breaker according to some embodiments of the present disclosure.

FIG. 9 is an eighth schematic structural view of a circuit breaker according to some embodiments of the present disclosure.

FIG. 10 is a ninth schematic structural view of a circuit breaker according to some embodiments of the present disclosure.

FIG. 11 is a tenth schematic structural view of a circuit breaker according to some embodiments of the present disclosure.

FIG. 12 is an eleventh schematic structural view of a circuit breaker according to some embodiments of the present disclosure.

FIG. 13 is a twelfth schematic structural view of a circuit breaker according to some embodiments of the present disclosure.

FIG. 14 is a thirteenth schematic structural view of a circuit breaker according to some embodiments of the present disclosure.

FIG. 15 is a fourteenth schematic structural view of a circuit breaker according to some embodiments of the present disclosure.

FIG. 16 is a fifteenth schematic structural view of a circuit breaker according to some embodiments of the present disclosure.

FIG. 17 is a sixteenth schematic structural view of a circuit breaker according to some embodiments of the present disclosure.

FIG. 18 is a seventeenth schematic structural view of a circuit breaker according to some embodiments of the present disclosure.

FIG. 19 is a schematic structural view showing a communication connection among an energy storage device, a circuit breaker, and a mobile terminal according to some embodiments of the present disclosure.

FIG. 20 is an eighteenth schematic structural view of a circuit breaker according to some embodiments of the present disclosure.

FIG. 21 is another schematic view showing an application scenario of a circuit breaker according to some embodiments of the present disclosure.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

Embodiments of the present disclosure provides a circuit breaker 100, which is described in detail below:

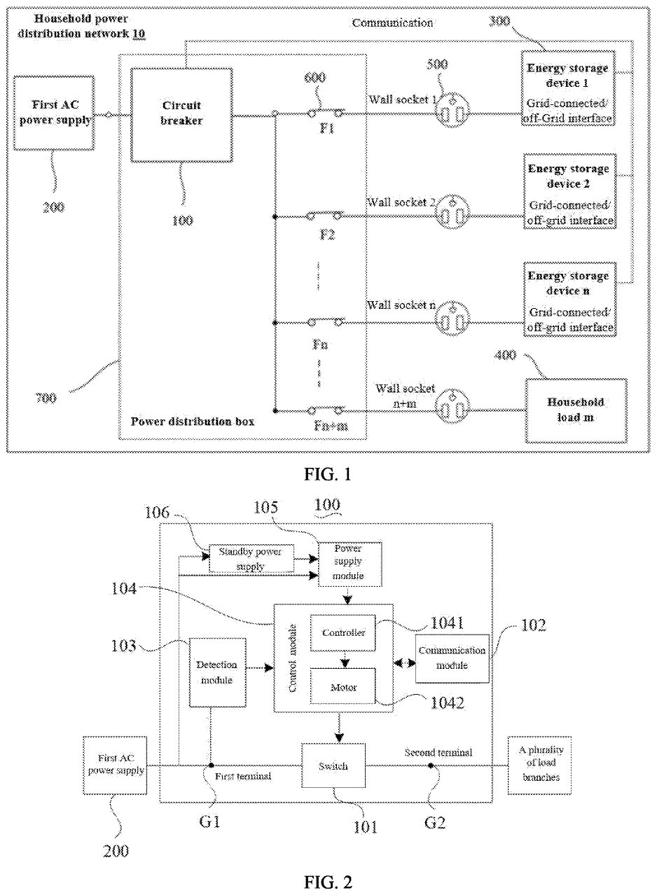

As illustrated in FIG. 1 and FIG. 2, the circuit breaker 100 according to the embodiments of the present disclosure is used in a household power distribution network 10. The household power distribution network 10 includes a first alternating current power supply 200, an energy storage device 300, and a plurality of load branches. The plurality of load branches is connected in parallel, and at least one of the plurality of load branches is connected to the energy storage device 300. The circuit breaker 100 includes a switch 101, a communication module 102, a detection module 103, and a control module 104. The switch 101 has a first terminal G1 connected to the first alternating current power supply 200 and a second terminal G2 connected to the plurality of load branches.

The first alternating current power supply 200 may be alternating current mains power provided by a power grid company or alternating current power outputted from a generator, and is a main power source for household power consumption. In addition to supplying power to the load and the circuit breaker 100, the first alternating current power supply 200 also charges the standby power supply 106 of the circuit breaker 100.

The first terminal G1 of the switch 101 is a terminal of the circuit breaker 100 connected to the first alternating current power supply 200, that is, a node at an input terminal of the circuit breaker 100, and also an input point for a detectable signal indicating a state of the first alternating current power supply 200. The first terminal G1 of the switch 101 is connected to the power supply module 105, to allow the first alternating current power supply 200 to supply power to the circuit breaker 100.

The second terminal G2 of the switch 101 is a terminal of the circuit breaker 100 connected to the plurality of load branches, that is, a node at an output terminal of the circuit breaker 100, and also an input point for a detectable signal indicating a state of the circuit breaker 100.

The load branches refer to power consumption circuits connected to the output terminal of the circuit breaker 100, may include lighting, sockets, home appliances, etc., and are usually a plurality of parallel branches equipped with a disconnect switch 600 and a wall socket 500. At least one of the plurality of load branches is connected to the energy storage device 300. When the first alternating current power supply 200 is de-energized, the energy storage device 300 can provide a second alternating current power supply to other load branches to realize emergency power supply.

The energy storage device 300 refers to an energy storage power supply that is connected to the at least one load branch and can output alternating current power via an inverter when the first alternating current power supply 200 is de-energized, so as to supply power to the loads on the load branch to which the energy storage device 300 is connected. The energy storage device 300 can communicate with the communication module 102 of the circuit breaker 100 and receive a signal from the control module 104 to determine whether to output power via inversion or disconnect the power supply.

It should be understood that the switch 101, as a direct actuator of the circuit breaker 100, controls the connection and disconnection between the first alternating current power supply 200 and the plurality of load branches. The first terminal G1 of the switch 101 is connected to the first alternating current power supply 200 and the second terminal G2 of the switch 101 is connected to the plurality of load branches. The switch 101 can be turned off or turned on under automatic control of the control module 104 of the circuit breaker 100, which achieves safe isolation between the first alternating current power supply 200 and the loads, ensuring normal operation of the system.

The communication module 102 communicates with the energy storage device 300.

Specifically, the communication module 102 receives an instruction from the control module 104 and performs bidirectional data communication with the energy storage device 300 via wired communication or wireless communication. The instruction received by the communication module 102 from the control module 104 includes state information of the first alternating current power supply 200. When transmitted to the energy storage device 300, the information can trigger the inverter output of the energy storage device 300 or disconnect the power supply. State information of the energy storage device 300, such as an electric quantity level of the energy storage device 300, can also be transmitted to the communication module 102, and then forwarded to the control module 104 by the communication module 102. Based on the feedback information from the energy storage device 300, the control module 104 determines whether to switch the power supply by controlling on and off of the switch 101.

The detection module 103 is connected to the first terminal G1 of the switch 101 and configured to detect whether the first terminal G1 of the switch 101 is de-energized and to generate a first detection signal indicating whether the first alternating current power supply 200 is de-energized.

The first detection signal is a logic signal generated by the detection module 103 during detection at the first terminal G1 of the switch 101, which can be recognized by the control module 104 and reflects the state of the first alternating current power supply 200 (energized or de-energized).

Specifically, the detection module 103 continuously monitors an input signal at the first terminal G1 of the switch 101. The input signal includes a raw electrical parameter (such as a voltage and a waveform) representing the state of the first alternating current power supply 200. Sampling, signal processing, comparison with a predetermined normal operating threshold, etc. are performed on the input signal, to generate a logic signal including the state information of the first alternating current power supply 200, i.e., the first detection signal.

The control module 104 is connected to the detection module 103 and the communication module 102 and capable of controlling the switch 101 to be turned on.

The control module 104 includes a controller 1041 and a motor 1042. The controller 1041 is configured to control operation of the motor 1042. The motor 1042 is capable of driving the switch 101 to be turned on or turned off.

Specifically, the controller 1041 of the control module 104 can determine a state of the first alternating current power supply 200 based on the first detection signal generated by the detection module 103. If the first alternating current power supply 200 is de-energized, the control motor 1042 drives the switch 101 to be turned off. If the first alternating current power supply 200 is normal, the switch 101 remains on.

In some embodiments, the communication module 102 is connected to the control module 104 and then to the detection module 103. The detection module 103 transmits the first detection signal to the control module 104, then the control module 104 forwards the first detection signal to the communication module 102.

It should be understood that the control module 104, as a control center of the circuit breaker 100, receives the first detection signal continuously monitored and generated by the detection module 103, which includes the state information of the first alternating current power supply 200 (e.g., mains power failure). On the other hand, after performing logical judgment on the first detection signal, the control module 104 first controls the on and off of the switch 101 (e.g., controlling the motor 1042 to drive the switch 101 to be turned off), and then generates a control instruction to control the communication module 102 to transmit the state information of the first alternating current power supply 200 to the energy storage device 300, to control a connection of the energy storage device 300 (e.g., activating the inverter output of the energy storage device 300).

In the circuit breaker 100 provided by the present disclosure, when the first alternating current power supply 200 is de-energized, the switch 101 is turned off, and the control module 104 is configured to transmit a first signal to the energy storage device 300 via the communication module 102, to allow the energy storage device 300 to supply the second alternating current power supply to other load branches of the plurality of load branches.

The second alternating current power supply refers to power outputted by the energy storage device 300 through inversion, and is used to supply power to the circuit breaker 100 and to other branch loads of the energy storage device 300 when the first alternating current power supply 200 is de-energized.

The first signal has two operating modes. In the first mode, after the detection module 103 determines that the first alternating current power supply 200 is de-energized, the control module 104 transmits a signal to the energy storage device 300 via the communication module 102. In this case, the first signal indicates that the first alternating current power supply 200 is de-energized, and the energy storage device 300 needs to determine that the first alternating current power supply 200 is de-energized based on the signal and supply power via the second alternating current power supply. In the second mode, the control module 104 directly transmits the first signal that requests activation of the energy storage device 300 to the energy storage device 300, and the energy storage device 300 is activated directly and supplies power via the second alternating current power supply.

It should be understood that, to guarantee higher safety, the detection module 103 continuously monitors signals of the first terminal G1 and the second terminal G2 of the switch 101. The first detection signal detected by the detection module 103 at the first terminal G1 of the switch 101 reflects the state of the first alternating current power supply 200 (e.g., the mains power), and the second detection signal detected by the detection module 103 at G1 reflects the state of the second alternating current power supply. When the circuit breaker 100 detects that the first alternating current power supply 200 is energized, the circuit breaker 100 transmits the second signal to the energy storage device 300 through the communication module 102. Upon receiving the second signal, the energy storage device 300 de-energizes, and transmits a signal indicating that the energy storage device 300 is de-energized to the communication module 102. The control module 104 determines that the first alternating current power supply 200 is energized and the energy storage device 300 is de-energized based on the first detection signal and the second detection signal, and controls the switch 101 to be turned on. By establishing a detection and isolation mechanism for a power supply state on the load side, the state of the energy storage device 300 on the load side can be obtained in a timely manner, which avoids a grid connection problem between the first alternating current power supply 200 and the second alternating current power supply provided by the energy storage device 300, which would be caused by turning-on of the switch 101 of the circuit breaker 100 while the load branches are connected to the second alternating current power supply. Since phases of alternating currents of the first alternating current power supply and the energy storage device 300 may not be synchronized, grid connection between the first alternating current power supply 200 and the second alternating current power supply may cause damage to the loads.

The embodiments of the present disclosure provide a circuit breaker 100, which includes the switch 101, the communication module 102, the detection module 103, and the control module 104. When the first alternating current power supply 200 (such as the mains power) is de-energized, the energy storage device 300 on the load side can provide the second alternating current power supply to supply power to the detection module 103, the communication module 102, and the control module 104. The detection module 103 detects the de-energization of the first alternating current power supply 200 connected to the first terminal G1 of the switch 101, generates the first detection signal indicating that the first alternating current power supply 200 is de-energized, and transmits the first detection signal to the control module 104. The switch 101 is driven by the motor 1042 under the control of the controller 1041 of the control module 104 to be turned off. Subsequently, the control module 104 transmits the de-energization information of the first alternating current power supply 200 to the communication module 102, which then transmits the first signal to the energy storage device 300. The energy storage device 300 outputs power via inversion to supply the second alternating current power supply to other load branches of the plurality of load branches. In the circuit breaker 100 according to the embodiments of the present disclosure, through the above process, the second alternating current power supply provided by the energy storage device 300 on the load side enables the circuit breaker 100 to be opened normally when the first alternating current power supply 200 is de-energized, and communication between the energy storage device 300 and the circuit breaker 100 to be restored. In this way, the energy storage device 300 can be controlled to output power via inversion to the load, maintaining safety and stability of the power supply system.

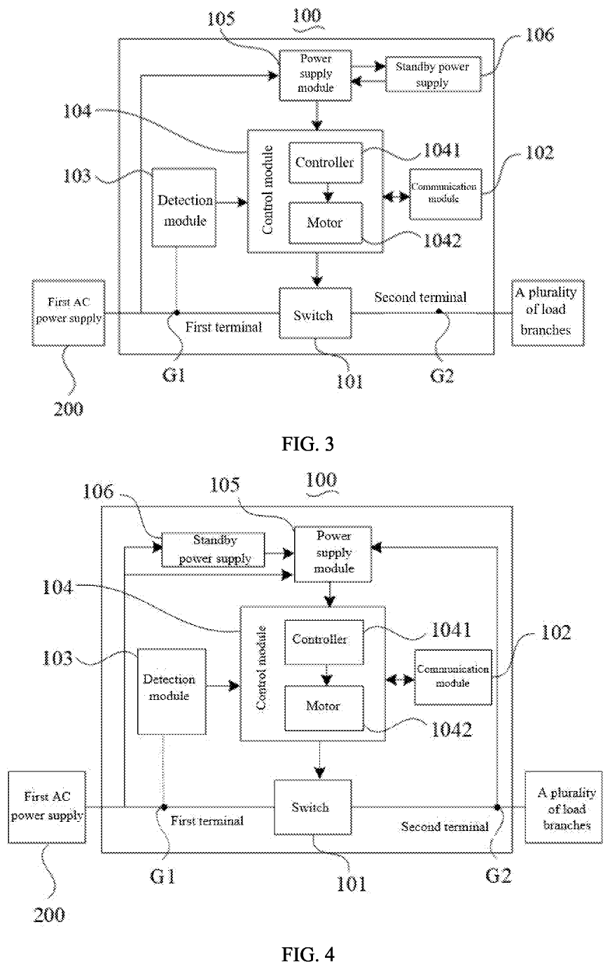

As illustrated in FIG. 2, FIG. 3, FIG. 4 and FIG. 8, in some embodiments, the circuit breaker 100 further includes a power supply module 105 connected to the first terminal G1 and/or the second terminal G2 of the switch 101. The first alternating current power supply 200 and/or the energy storage device 300 supply power to the communication module 102, the detection module 103, and the control module 104 through the power supply module 105.

The first terminal G1 of the switch 101 is connected to the first alternating current power supply 200, which can supply power to the circuit breaker 100. The second terminal G2 of the switch 101 is connected to the second alternating current power supply provided by the energy storage device 300, which can supply power to the circuit breaker 100.

It should be understood that when the first alternating current power supply 200 operates normally, the power supply module 105 converts a high-voltage alternating current (e.g., 220V) of the first alternating current power supply 200 into a low-voltage direct current (e.g., 5V, 3.3V) through a connection to the first terminal G1 of the switch 101, supplying power to the detection module 103, the communication module 102, and the control module 104 inside the circuit breaker 100. When the first alternating current power supply 200 is de-energized, the power supply module 105 converts the second alternating current power supply provided by the energy storage device 300 into a low-voltage direct current through the second terminal G2 of the switch 101, supplying power to the detection module 103, the communication module 102, and the control module 104 inside the circuit breaker 100. Alternatively, when the first alternating current power supply 200 is de-energized, the power supply module 105 supplies power to the modules of the circuit breaker 100 through a power supply other than the first alternating current power supply 200.

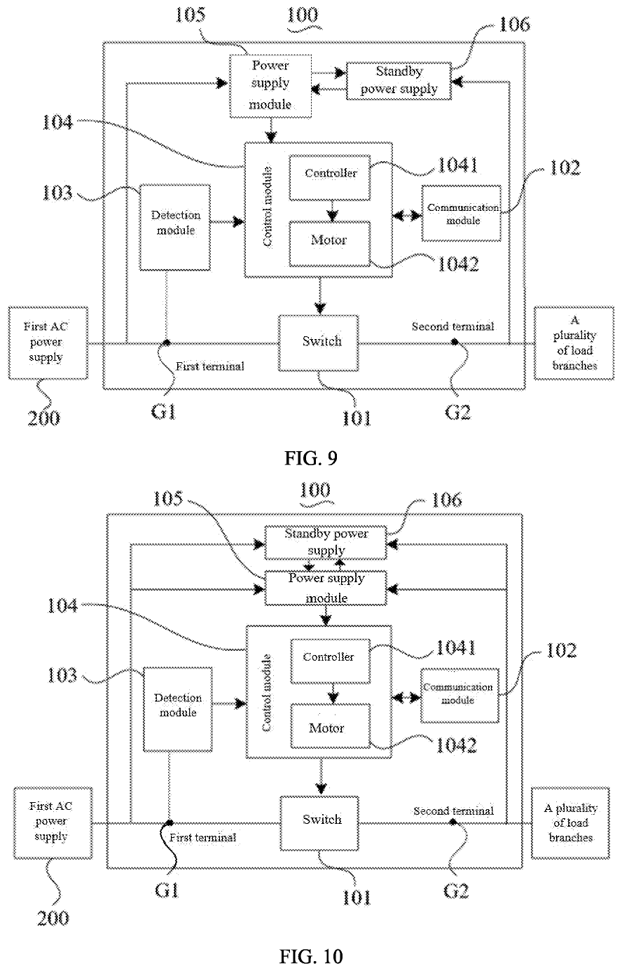

Specifically, the power supply module 105 may be connected to the first terminal G1 and the second terminal G2 of the switch 101 and supply power to each module of the circuit breaker 100 through the first alternating current power supply or the second alternating current power supply (the first alternating current power supply and the second alternating current power supply do not supply power simultaneously). Alternatively, as illustrated in FIG. 4, the power supply module 105 may be connected to the first terminal G1 of the switch 101 and supply power to each module of the circuit breaker 100 through the first alternating current power supply. Alternatively, as illustrated in FIG. 9, the power supply module 105 may be connected to the second terminal G2 of the switch 101 and supply power to each module of the circuit breaker 100 through the second alternating current power supply.

Specifically, after the first alternating current power supply is de-energized, bidirectional data communication between the energy storage device 300 and the circuit breaker 100 is interrupted. The energy storage device 300 automatically switches to output power via inversion, generating the second alternating current power supply, which supplies power to the circuit breaker 100 through the power supply module 105, to restore the bidirectional data communication between the energy storage device 300 and the circuit breaker 100. Based on a communication status, the second alternating current power supply, generated by the energy storage device 300 via inversion, supplies power to the loads on the other load branches of the plurality of load branches in the household power distribution network.

As illustrated in FIG. 2, FIG. 3, FIG. 4, and FIG. 9, in some embodiments, the standby power supply 106 is connected between the first terminal G1 of the switch 101 and the power supply module 105, or the standby power supply 106 is connected to the power supply module 105.

The standby power supply 106 includes a battery or a capacitor. In a mains power de-energization scenario, an electric quantity of the battery or the capacitor should be sufficient to allow the motor 1042 of the control module 104 of the circuit breaker 100 to drive the switch 101 to be turned off, and to support the bidirectional data communication between the communication module 102 and the energy storage device 300.

It should be understood that the standby power supply 106 is generally a direct current power supply. Therefore, when the first alternating current power supply 200 in the power grid is de-energized, the standby power supply 106 can independently supply power to the detection module 103, the communication module 102, and the control module 104. The standby power supply 106 can at least ensure that, after the first alternating current power supply 200 is de-energized, state detection of the first alternating current power supply 200, turning off of the switch 101, and maintenance of the bidirectional data communication can still be completed, improving reliability of the system.

Specifically, when the standby power supply 106 is connected between the first terminal G1 of the switch 101 and the power supply module 105, the first alternating current power supply 200 can supply power to the standby power supply 106. After storing a certain amount of electricity, the standby power supply 106 may also be directly connected to the power supply module 105. In addition, when the first alternating current power supply 200 operates normally, the standby power supply 106 can be charged through the power supply module 105.

In some embodiments, the standby power supply 106 is connected to the power supply module 105. The standby power supply 106 supplies power to the communication module 102, the detection module 103, and the control module 104 through the power supply module 105.

It should be understood that, when the first alternating current power supply 200 is de-energized, the standby power supply 106 can replace the first current power supply to supply power to the communication module 102, the detection module 103, and the control module 104, so that the circuit breaker 100 can be opened in a timely manner and communicate with the energy storage device 300.

As illustrated in FIG. 4, FIG. 9, FIG. 10, and FIG. 18, in some embodiments, the standby power supply 106 is connected to the first terminal G1 and/or the second terminal G2 of the switch 101, to be charged through the first alternating current power supply 200 and/or the energy storage device 300.

The second terminal G2 of the switch 101 is connected to the second alternating current power supply provided by the energy storage device 300, and the second alternating current power supply can supply power to the circuit breaker 100.

It should be understood that the standby power supply 106, as an independent power supply in the circuit breaker 100, needs to be directly connected to the power supply module 105 to supply power to each module. The standby power supply 106 may have a terminal connected to the first terminal G1 of the switch 101 and another terminal connected to the power supply module 105, or both the two terminals of the standby power supply 106 may be directly connected across the power supply module 105. Both configurations allow the first alternating current power supply 200 to charge the standby power supply 106. When one terminal of the standby power supply 106 is connected to the first terminal G1 of the switch 101, the power supply module 105 may be connected to the second terminal G2 of the switch 101. Therefore, the standby power supply 106 of the circuit breaker 100 can be charged by the second alternating current power supply provided by the energy storage device 300 on the load side.

Moreover, as illustrated in FIG. 9, after being connected across the power supply module 105, the standby power supply 106 may be further connected to the second terminal G2. In this way, the standby power supply 106 can be directly charged by the second alternating current power supply provided by the energy storage device 300 on the load side.

As illustrated in FIG. 10, after being connected across the power supply module 105, the standby power supply 106 may be further connected to the first terminal G1 and the second terminal G2. In this way, the standby power supply 106 can be alternately charged by the first alternating current power supply 200 (such as the mains power) and the second alternating current power supply provided by the energy storage device 300 on the load side.

For example, as illustrated in FIG. 4, a front end of the power supply module 105 in the circuit breaker 100 is supplied with power by the standby power supply 106 and the second alternating current power supply input from the energy storage device 300 on the load side. When the first alternating current power supply 200 is available, it can charge the standby power supply 106 and also supply power to the circuit breaker 100, controlling remote intelligent closing and opening of the circuit breaker 100. When the first alternating current power supply 200 is de-energized, if the switch 101 of the circuit breaker 100 is in an on state, the standby power supply 106 can enable the motor 1042 to control the circuit breaker 100 to be intelligently opened, realizing a self-recovery disconnection function of the circuit breaker 100, and synchronously updating the states of the first alternating current power supply 200 and the circuit breaker to the energy storage device 300. When the first alternating current power supply 200 is de-energized and the circuit breaker is opened, the energy storage device 300 can perform inversion to supply power to the load. When the first alternating current power supply 200 returns to normal, the circuit breaker 100 updates the state of the first alternating current power supply 200 to the energy storage device 300, which can then stop outputting power via inversion and communicate synchronously with the circuit breaker 100. After receiving an inversion-off state of the energy storage device 300, the circuit breaker 100 is closed and the load is supplied with power by the first alternating current power supply 200.

The embodiments of the present disclosure provide a circuit breaker 100, which includes the switch 101, the communication module 102, the detection module 103, the control module 104, the power supply module 105, and the standby power supply 106. When the first alternating current power supply 200 (such as the mains power) is de-energized, the standby power supply 106 can supply power to the detection module 103, the communication module 102, and the control module 104 through the power supply module 105. The detection module 103 detects the de-energization of the first alternating current power supply 200 connected to the first terminal G1 of the switch 101, generates the first detection signal indicating that the first alternating current power supply 200 is de-energized, and transmits the first detection signal to the control module 104. The switch 101 is driven by the motor 1042 under the control of the controller 1041 of the control module 104 to be turned off. Subsequently, the control module 104 transmits the de-energization information of the first alternating current power supply 200 to the communication module 102, which then transmits the first signal to the energy storage device 300. The energy storage device 300 performs inversion to supply the second alternating current power supply to other load branches of the plurality of load branches. In the circuit breaker 100 according to the embodiments of the present disclosure, the addition of the standby power supply 106 enables the circuit breaker 100 to reliably detect de-energization of the first alternating current power supply 200. In this way, the power output via inversion of the energy storage device 300 is accurately controlled, which achieves seamless power supply switching between the mains power and the energy storage device 300, increasing the safety and flexibility of the power supply system. The circuit breaker is separately supplied with power by the standby power supply, reducing mounting costs.

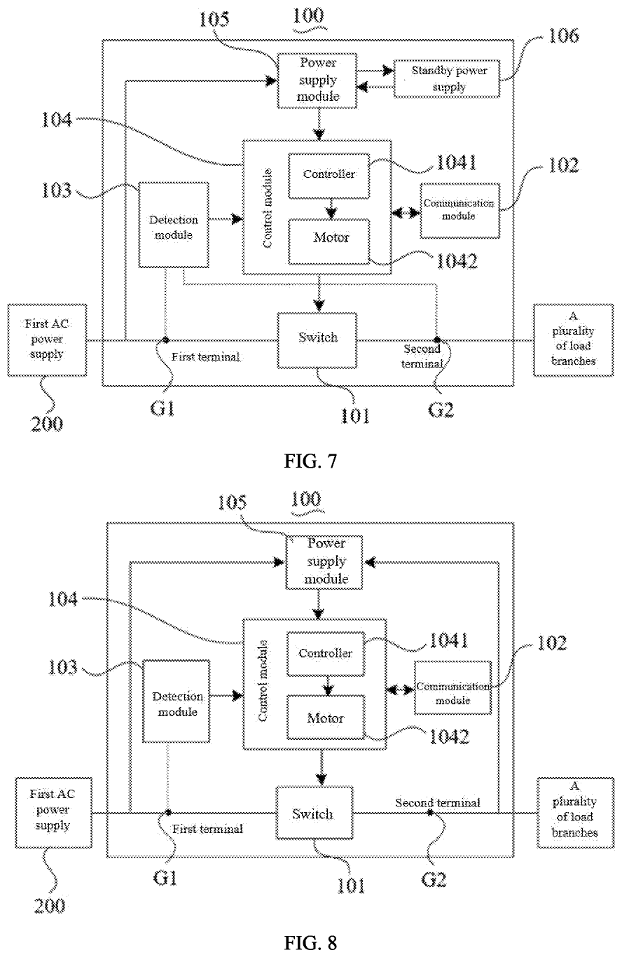

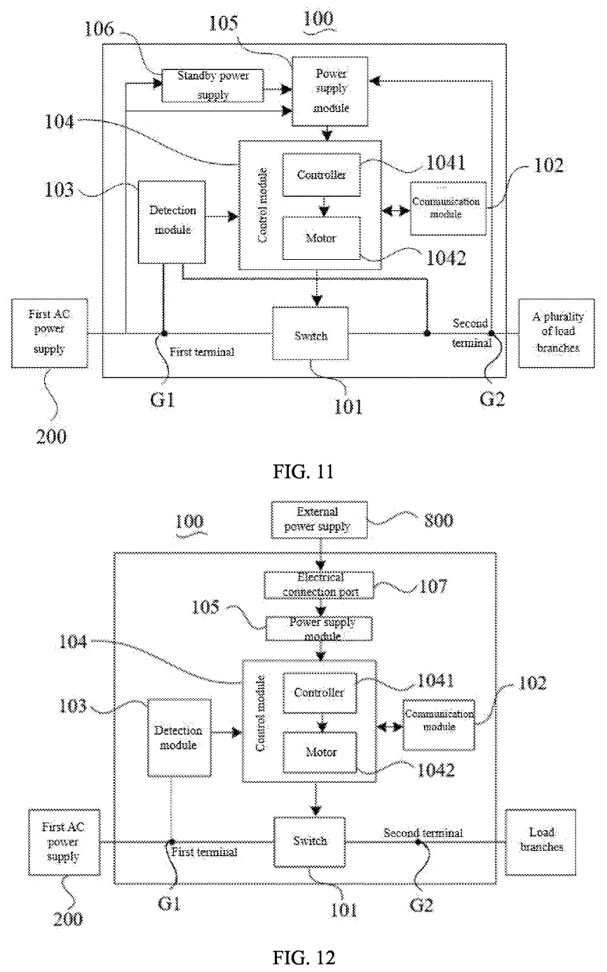

As illustrated in FIG. 7, FIG. 11, and FIG. 14 to FIG. 18, in some embodiments, the detection module 103 is connected to the second terminal G2 of the switch 101. The detection module 103 is further configured to detect whether the second terminal G2 of the switch 101 is de-energized and to generate a second detection signal indicating whether the energy storage device 300 is de-energized.

The second detection signal is a logical signal generated by the detection module 103 during detection at the second terminal G2 of the switch 101, which can be recognized by the control module 104 and reflects the state of the second alternating current power supply (energized or de-energized).

Specifically, the detection module 103 continuously monitors a load side signal at the second terminal G2 of the switch 101. The load side signal includes a raw electrical parameter (such as a voltage and a waveform) representing the state of the second alternating current power supply. Sampling, signal processing, and comparison with a predetermined normal operating threshold, etc. are performed on the input signal, to generate a logic signal including state information of the second alternating current power supply, i.e., the second detection signal.

Specifically, the controller 1041 of the control module 104 can determine the states of the first alternating current power supply 200 (such as the mains power) and the energy storage device 300 based on the first detection signal and the second detection signal generated by the detection module 103, and then control the motor 1042 to drive the switch 101 to be turned on or turned off, in such a manner that the switch 101 is turned off if the first alternating current power supply 200 is de-energized and remains on if the first alternating current power supply 200 returns to normal.

In some embodiments, the control module 104 is further configured to control the switch 101 to be turned on when determining, based on the first detection signal and the second detection signal, that the first alternating current power supply 200 is energized and the energy storage device 300 is de-energized.

It should be understood that, to guarantee higher safety, the detection module 103 continuously monitors signals of the first terminal G1 and second terminal G2 of the switch 101. The first detection signal detected by the detection module 103 at the first terminal G1 of the switch 101 reflects the state of the first alternating current power supply 200 (the mains power), and the second detection signal detected by the detection module 103 at G1 reflects the state of the second alternating current power supply (the energy storage device 300). By establishing the detection and isolation mechanism for the power supply state on the load side, the state of the energy storage device 300 on the load side can be obtained in a timely manner, which avoids a grid connection problem between the mains power and the energy storage device 300, which would be caused by turning-on of the switch 101 of the circuit breaker 100 while the load branches are connected to the second alternating current power supply. Since phases of alternating currents of the mains power and the energy storage device 300 may not be synchronized, grid connection between the mains power and the energy storage device 300 may cause damage to the loads.

The embodiments of the present disclosure provide a circuit breaker 100, which includes the switch 101, the communication module 102, the detection module 103, and the control module 104. When the first alternating current power supply 200 (such as the mains power) is de-energized, the detection module 103 detects that the first alternating current power supply 200 connected to the first terminal G1 of the switch 101 is de-energized, generates the first detection signal indicating that state of the first alternating current power supply 200, and transmits the first detection signal to the control module 104. The switch 101 is driven by the motor 1042 under the control of the controller 1041 of the control module 104 to be turned off. In this process, the control module 104 transmits the de-energization information of the first alternating current power supply 200 to the communication module 102, which then transmits the first signal to the energy storage device 300. The energy storage device 300 performs inversion to supply the second alternating current power supply to other load branches of the plurality of load branches. When the first alternating current power supply 200 is restored, the detection module 103 detects the first terminal G1 and the second terminal G2 of the switch 101, generates the first detection signal indicating the state of the first alternating current power supply 200 and the second detection signal indicating the state of the second alternating current power supply, and transmits the first detection signal and the second detection signal to the control module 104. Based on the first detection signal and the second detection signal, the control module 104 determines that the first alternating current power supply 200 is energized and the energy storage device 300 is de-energized. The control module 104 transmits the second signal to the energy storage device 300 via the communication module 102 to allow the energy storage device 300 to stop supplying power. Finally, the control module 104 controls the switch 101 to be turned on. In the above process, power is supplied continuously by the external power supply 800 or by cooperative power supply from any one of the first alternating current power supply 200, the second alternating current power supply provided by the energy storage device 300, and the standby power supply 106. In the circuit breaker 100 according to the embodiments of the present disclosure, the isolation and switching between the first alternating current power supply and the second alternating current power supply are achieved by detecting states of the power supplies connected to the two terminals of the circuit breaker 100, improving safety and reliability of the system and realizing more precise power management and control.

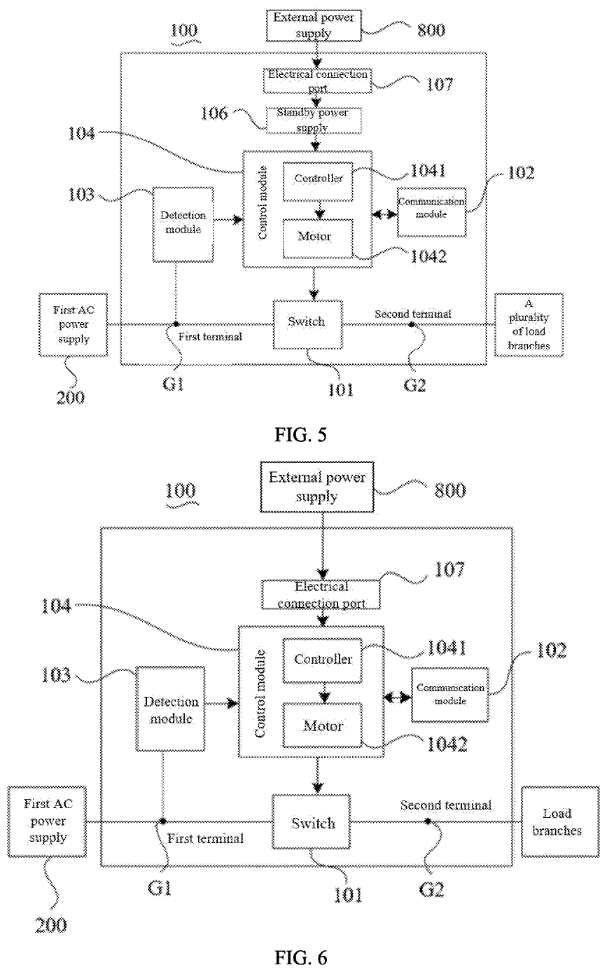

As illustrated in FIG. 5, FIG. 6, and FIG. 12 to FIG. 17, in some embodiments, the circuit breaker 100 includes an electrical connection port 107. The electrical connection port 107 is connected to an external power supply 800 to allow the external power supply to supply power to the detection module 103, the communication module 102, and the control module 104.

The external power supply 800, as an independent charging power supply outside the circuit breaker 100, can provide appropriate voltage and current to each module of the circuit breaker 100, so as to directly supply power to each module of the circuit breaker 100. To guarantee normal charging, the external power supply 800 should have an interface compatible with the circuit breaker 100.

Specifically, the electrical connection port 107 connects the circuit breaker 100 to the external power supply 800, in such a manner that the external power supply 800 can provide power for safe opening of the circuit breaker 100 and communication with the energy storage device 300 when the first alternating current power supply 200 is de-energized or energized.

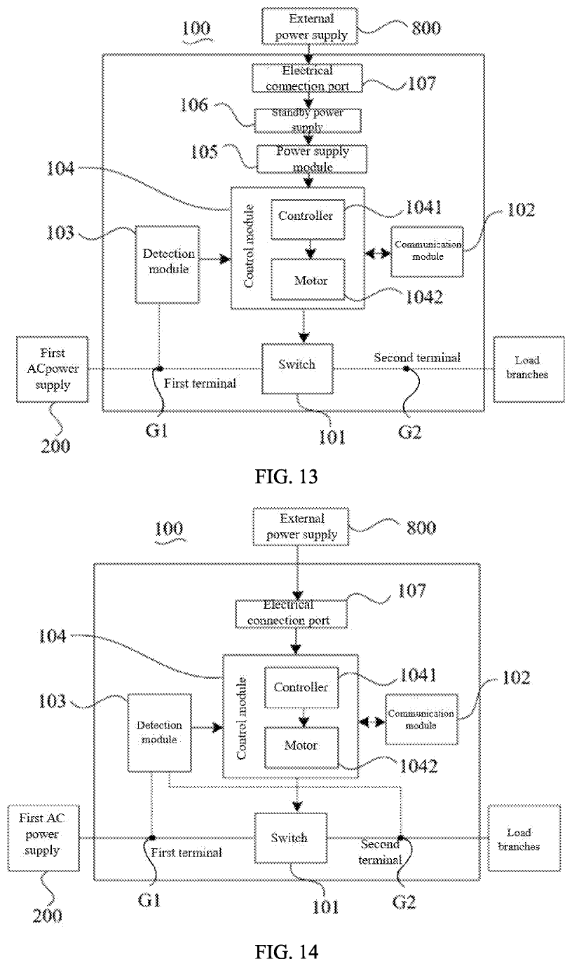

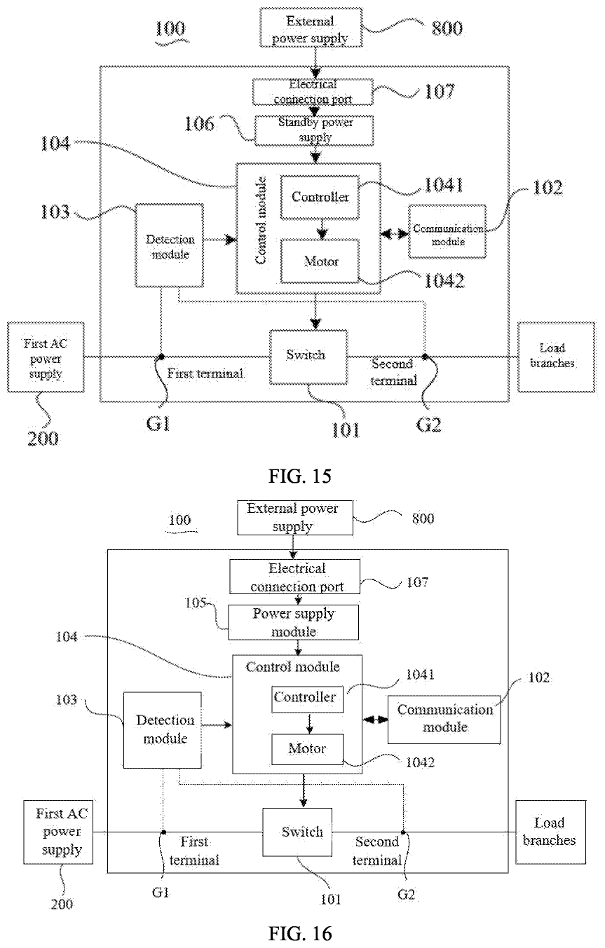

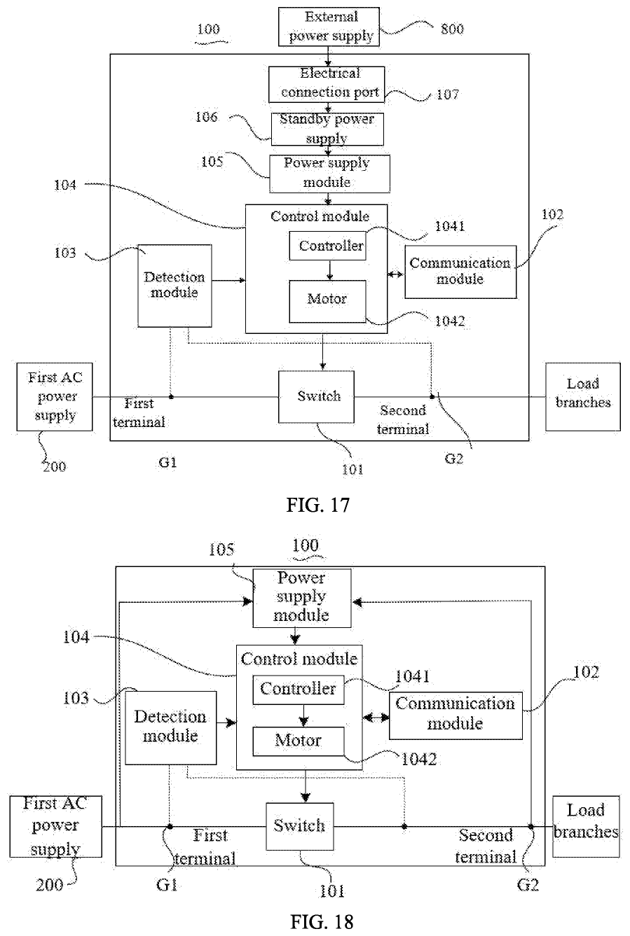

As illustrated in FIG. 5, FIG. 13, FIG. 15, and FIG. 17, in some embodiments, the circuit breaker 100 further includes a standby power supply 106 configured to supply power to the detection module 103, the communication module 102, and the control module 104 when the first alternating current power supply 200 is de-energized. The standby power supply 106 is connected to the external power supply 800 via the electrical connection port 107, to allow the external power supply 800 to charge the standby power supply 106.

It should be understood that the external power supply 800 can provide stable and continuous electric energy to the standby power supply 106 when the electric quantity of the standby power supply 106 is insufficient to support the motor 1042 of the control module 104 of the circuit breaker 100 to drive the switch 101 to be turned off and to support the bidirectional data communication between the communication module 102 and the energy storage device 300, to maintain normal operation of the circuit breaker 100.

It should be understood that the external power supply 800, as an independent charging component outside the circuit breaker 100, can directly provide appropriate voltage and current to each module of the circuit breaker 100, to directly supply power to each module of the circuit breaker 100. The external power supply 800 can also charge the standby power supply 106 via the electrical connection port 107, ensuring that the standby power supply 106 has sufficient electric energy to support basic operations of the modules of the circuit breaker 100 when the first alternating current power supply 200 is de-energized. To guarantee normal charging, the external power supply 800 should have an interface compatible with the circuit breaker 100.

Specifically, the electrical connection port 107 connects the circuit breaker 100 to the external power supply 800, in such a manner that the external power supply 800 can provide power for the safe opening of the circuit breaker 100 and the communication with the energy storage device 300 when the first alternating current power supply 200 (such as the mains power) is energized or de-energized.

As illustrated in FIG. 12, FIG. 13, FIG. 16, and FIG. 17, in some embodiments, the circuit breaker 100 further includes a power supply module 105 connected to the electrical connection port 107. The external power supply 800 supplies power to the detection module 103, the communication module 102, and the control module 104 through the power supply module 105.

It should be understood that the power supply module 105 can convert the high-voltage alternating current (e.g., 220V) into the low-voltage stable direct current (e.g., 5V, 3.3V) to supply power to the detection module 103, the communication module 102, and the control module 104 in the circuit breaker 100. As illustrated in FIG. 12 and FIG. 16, the power supply module 105 is directly connected to the external power supply 800 via the electrical connection port 107. The electric energy provided by the external power supply 800 is converted into a suitable voltage by the power supply module 105 for the normal operation of the circuit breaker 100. As illustrated in FIG. 13 and FIG. 17, the power supply module 105 is connected to the standby power supply 106 and then to the external power supply 800 via the electrical connection port 107. The external power supply 800 is responsible for charging the standby power supply 106, and the electric energy provided by the standby power supply 106 is converted into a suitable voltage by the power supply module 105 for the normal operation of the circuit breaker 100.

The embodiments of the present disclosure provide a circuit breaker 100, which includes the switch 101, the communication module 102, the detection module 103, the control module 104, and the electrical connection port 107. When the first alternating current power supply 200 (e.g., the mains power) is de-energized, the electrical connection port 107, through the connection with the external power supply 800, can maintain power supply to the detection module 103, the communication module 102, and the control module 104 without being affected by the state of the first alternating current power supply. The detection module 103 detects that the first alternating current power supply 200 connected to the first terminal G1 of the switch 101 is de-energized, generates the first detection signal indicating that the first alternating current power supply 200 is de-energized, and transmits the first detection signal to the control module 104. The switch 101 is driven by the motor 1042 under the control of the controller 1041 of the control module 104 to be turned off. Subsequently, the control module 104 transmits the de-energization information of the first alternating current power supply 200 to the communication module 102, which then transmits the first signal to the energy storage device 300. The energy storage device 300 outputs power via inversion to supply the second alternating current power supply to the other load branches of the plurality of load branches. In the circuit breaker 100 according to the embodiments of the present disclosure, the external power supply 800 can supply continuous power to the circuit breaker 100. The electrical connection port 107 is connected to the external power supply 800 to supply power to the circuit breaker 100, enabling the circuit breaker 100 to achieve stable de-energization detection of the first alternating current power supply 200 and timely isolation between the first alternating current power supply 200 and the energy storage device 300. In this way, safe power supply switching between the first alternating current power supply 200 and the energy storage device 300 is achieved. Equipping the circuit breaker 100 with an independent external power supply 800 can reduce a size of the circuit breaker 100, which increases mounting flexibility of the circuit breaker 100 and reduces the mounting costs, facilitating energy management of the power distribution system.

In some embodiments, the switch 101 is a normally open switch 101. Alternatively, the control module 104 controls the switch 101 to be turned off when determining that the first alternating current power supply 200 is de-energized based on the first detection signal.

The normally open switch 101 achieves automatic control through an operating principle of an electromagnetic relay, i.e., contacts remain open when an electromagnet coil is de-energized and is closed to form a circuit when the electromagnet coil is energized.

Specifically, in the embodiments provided by the present disclosure, there are two ways for the circuit breaker 100 to open. First, the switch 101 is the normally open switch 101, when the first alternating current power supply 200 is de-energized, the normally open switch 101 is automatically opened under the action of the relay, and other power supplies (such as the standby power supply 106, the external power supply 800, and the second alternating current power supply provided by the energy storage device 300) replace the first alternating current power supply 200 to supply power to each module of the circuit breaker 100. When the detection module 103 detects the first detection signal and confirms that the first alternating current power supply 200 returns to normal, the controller 1041 of the control module 104 controls the motor 1042 to drive the switch 101 to be turned on based on the first detection signal. Secondly, the switch 101 is not the normally open switch 101, when the first alternating current power supply 200 is de-energized, other power supplies replace the first alternating current power supply 200 to supply power to each module of the circuit breaker 100. When the detection module 103 detects the first detection signal and confirms that the first alternating current power supply 200 is de-energized, the controller 1041 of the control module 104 controls the motor 1042 to drive the switch 101 to be turned off based on the first detection signal. When the first alternating current power supply 200 returns to normal, the detection module 103 detects the first detection signal and confirms that the first alternating current power supply 200 returns to normal. Based on the first detection signal, the controller 1041 of the control module 104 controls the motor 1042 to drive the switch 101 to be turned on.

In some embodiments, the control module 104 is further configured to transmit the first signal to the energy storage device 300 via the communication module 102 when the first alternating current power supply 200 is de-energized and an electric quantity of the energy storage device 300 is greater than a predetermined standby electric quantity, to allow the energy storage device 300 to supply a second alternating current power supply to the other load branches of the plurality of load branches.

In some embodiments, the control module 104 is further configured to, when the electric quantity of energy storage device 300 is less than or equal to the predetermined standby electric quantity, transmit a power supply stopping signal to the energy storage device 300 via the communication module 102 to allow the energy storage device 300 to stop supplying the second alternating current power supply to the other load branches of the plurality of load branches, and to control the switch 101 to be turned on.

The predetermined standby electric quantity refers to a predetermined minimum electric quantity threshold in the energy storage device 300. This electric quantity can at least meet basic power requirements of critical loads (such as lighting, refrigerators, and medical devices) in the household power distribution network 10 for a certain period of time.

In some embodiments, the control module 104 is further configured to control the switch 101 to be turned on when the energy storage device 300 stops supplying power.

In some embodiments, the control module 104 is further configured to transmit a second signal to the energy storage device 300 via the communication module 102 when determining, based on the first detection signal, that the first alternating current power supply 200 is energized, to allow the energy storage device 300 to stop supplying power.

The second signal has two operating modes. In the first mode, after the detection module 103 determines that the first alternating current power supply 200 is restored, the control module 104 transmits the signal to the energy storage device 300 via the communication module 102. This second signal indicates that the first alternating current power supply 200 returns to normal, and the energy storage device 300, based on the second signal, determines that the first alternating current power supply 200 has been energized and then stops supplying power. In the second mode, the control module 104 directly transmits the second signal for stopping supplying power to the energy storage device 300, in such a manner that the energy storage device 300 directly stops supplying power.

Specifically, the communication module 102 obtains electric quantity information through continuous bidirectional data communication with the energy storage device 300 and transmits the information to the control module 104. The controller 1041 of the control module 104 controls the motor 1042 accordingly based on an electric quantity Q of the energy storage device 300 and a predetermined standby electric quantity Q0. When the first alternating current power supply 200 is de-energized: if Q is greater than Q0, it indicates that the energy storage device 300 has a sufficient electric quantity to supply the load. The communication module 102 transmits the first signal to the energy storage device 300, to allow the energy storage device 300 to output power via inversion to supply the second alternating current power supply to the other load branches of the plurality of load branches; if Q is less than or equal to Q0, it indicates that the energy storage device 300 does not have sufficient electric quantity to supply the load. The communication module 102 transmits the power supply stopping signal to the energy storage device 300, to allow the energy storage device 300 to stop outputting power via inversion and stop supplying the second alternating current power supply to the other load branches of the plurality of load branches, avoiding over-discharge. Also, the communication module 102 controls the switch 101 to be turned on, and waits for the first AC power source 200 to be restored, after which it continues supplying power to the load using the first alternating current power supply 200.

In some embodiments, the energy storage device 300 replaces the first alternating current power supply 200 to supply power to the load. The energy storage device 300 can also be configured for daily household power consumption, and autonomously set a power usage plan when the first alternating current power supply 200 operates normally.

Specifically, when the first alternating current power supply 200 operates normally, the circuit breaker 100 can control the motor 1042 to turn off the switch 101 according to user settings, the control module 104 synchronously transmits the state information indicating that the switch 101 is turned off to the communication module 102, and the communication module 102 informs the energy storage device 300 of the state of the circuit breaker 100 via wired communication or wireless communication, and simultaneously sends an inverter output instruction to the energy storage device 300 to allow the energy storage device 300 to supply power to other branch loads.

For example, in actual household power consumption, peak and off-peak electricity may be divided according to the power grid load. The peak and off-peak electricity refers to dividing a power consumption time period into a peak period and an off-peak period throughout the day, with different electricity prices for different time periods. Typically, the electricity price is higher during the peak period and lower during the off-peak period. The solution according to the embodiments of the present disclosure achieves the following functions: during a peak power consumption period, the control module 104 controls the circuit breaker 100 to be opened, to reduce or avoid the use of high-cost electricity during the peak period. Instead, the energy storage device 300, which has a lower electricity price cost is used to reduce power consumption costs. During the off-peak power consumption period, the circuit breaker 100 is controlled to be closed, to supply power and charge the energy storage device 300.

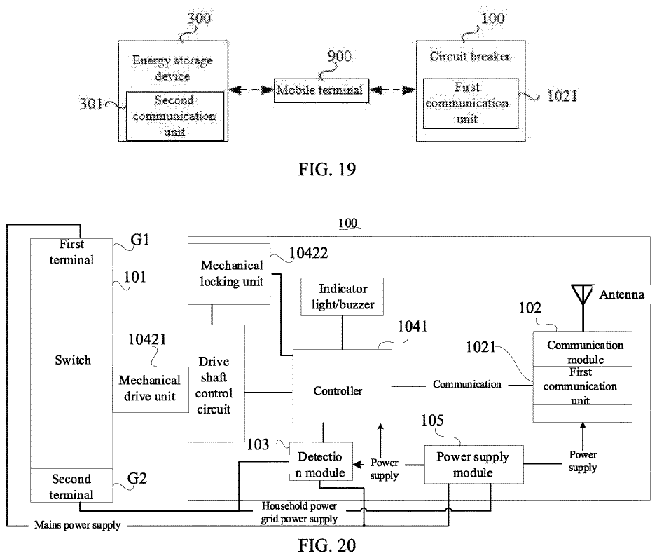

As illustrated in FIG. 19, in some embodiments, each of the circuit breaker 100 and the energy storage device 300 is communicatively connected to the same mobile terminal 900. The energy storage device 300 can establish a communication connection with the circuit breaker 100 through the mobile terminal 900. The circuit breaker 100 can be configured to control the power supply from the energy storage device 300 and the household load 400, and transmit the power supply status to the mobile terminal 900 through communication, in such a manner that the mobile terminal 900 can display power supply information.

For example, the circuit breaker 100 can be bound to a household power consumption application on the mobile terminal 900 for communication connection. If the energy storage device 300 supports the wireless communication, it can also communicate with the circuit breaker 100 through the household power consumption application on the mobile terminal 900. When the bound energy storage device 300 is powered on, it can communicate with the circuit breaker 100 via the wireless communication.

Specifically, after the circuit breaker 100, the energy storage device 300, and the mobile terminal 900 establish mutual communication relationships, the circuit breaker 100 can control the energy storage device 300 to activate its alternating current output function to output the alternating current when detecting that the mains power is de-energized. In addition, the circuit breaker 100 can also transmit, to the household power consumption application on the mobile terminal 900, the power supply status in which the energy storage device 300 supplies power to the household load 400 by activating its alternating current output function, and the power supply status can be displayed on the application of the mobile terminal 900. This power supply status can include information such as an electrical connection status between the energy storage device 300 and the household load 400, and a power supply duration.

For example, the application on the mobile terminal 900 can display the electrical connection status between the energy storage device 300 and the household load 400. If the electrical connection between the energy storage device 300 and the household load 400 is normal, the energy storage device 300 can supply power to the household load 400 normally. Therefore, the application displays a state indicating that the energy storage device 300 and the household load 400 are connected normally. If the electrical connection between the energy storage device 300 and the household load 400 is disconnected, the energy storage device 300 stops supplying power to the household load 400. Therefore, the application displays a state indicating that the energy storage device 300 and the household load 400 are disconnected.

In this way, the user can conveniently know the real-time power supply status of the energy storage device 300 to the household load 400 through the mobile terminal 900.

As illustrated in FIG. 19, in some embodiments, the communication module 102 of the circuit breaker 100 includes a first communication unit 1021. The energy storage device 300 includes a second communication unit 301. Both the first communication unit and the second communication unit 1021 are communicatively connected to the mobile terminal 900. The second communication unit 301 can establish a communication connection with the first communication unit 1021 through the mobile terminal 900.

That is, the circuit breaker 100 of the present disclosure can have a wired or wireless communication function, and is provided with the first communication unit 1021, which may include an IoT card, etc. The connected energy storage device 300 can also have a wired or wireless communication function, and is provided with the second communication unit 301, which may also include an IoT card, etc. The first communication unit 1021 and the second communication unit 301 can be mutually bound via the mobile terminal 900 to establish a wireless communication connection, which enables the circuit breaker 100 to remotely and intelligently control the connection and disconnection between the energy storage device 300 and the household load 400 via the mobile terminal 900, thereby achieving greater intelligent.

In addition, it should be understood that if the user selects the energy storage device 300 without the wireless communication function, the energy storage device 300 cannot be bound to the circuit breaker 100. Therefore, the connection and disconnection of the energy storage device 300 can be manually operated by the user, in such a manner that the energy storage device 300 without the wireless communication function can also provide household emergency standby power.

In some embodiments, the circuit breaker 100 is further configured to receive a user control instruction from the mobile terminal 900 and control the connection status between the energy storage device 300 and the household load 400 according to the user control instruction.

Specifically, the user control instruction may include, for example, an on-off control instruction for the energy storage device 300, a control instruction to adjust output power of the energy storage device 300, an on-off control instruction for the circuit breaker 100, or other control instructions, which are not limited herein.

It should be understood that, since the circuit breaker 100, the energy storage device 300, and the mobile terminal 900 establish the mutual communication relationships, not only can the circuit breaker 100 and the energy storage device 300 transmit information to the mobile terminal 900 and display the information on the application of the mobile terminal 900, but likewise, the user can also perform operations such as remote on-ff control of the energy storage device 300 and remote control of the circuit breaker 100 through the household power consumption application on the mobile terminal 900, making it more convenient, more efficient, and more intelligent.

In this way, in the present disclosure, a local area network is established by binding the energy storage device 300 with the wireless communication function to the circuit breaker 100 through the same mobile terminal 900. Consequently, the user remotely controls the energy storage device 300 and the circuit breaker 100 through the network on the mobile terminal 900, facilitating user operation and management and making control more intelligent.

In some embodiments, when the energy storage device 300 is powered on, the circuit breaker 100 is configured to read energy storage information of the energy storage device 300 and displays the energy storage information on the mobile terminal 900.

Specifically, the energy storage information includes a model number, output power, remaining capacity, and other data of the energy storage device 300.

In this way, in the present disclosure, the local area network is established by binding the energy storage device 300 with the wireless communication function to the circuit breaker 100 through the same mobile terminal 900. The circuit breaker 100 can automatically read the energy storage information of the energy storage device 300, transmit the energy storage information to the mobile terminal 900, and display it on the mobile terminal 900, allowing the user to view the energy storage information of the energy storage device 300 in real time via the mobile terminal 900.

In some embodiments, the circuit breaker 100 is further configured to send a prompt indicating that the mains power is restored upon detecting restoration of the mains power when the energy storage device 300 supplies power to the household load 400.

Specifically, if the mains power is restored while the energy storage device 300 is supplying power to the household load 400, the circuit breaker 100 detects this event and may notify the user via a preset notification method. For example, it can remind the user of this event through an audible and visual alarm or push an application message to a mobile terminal 900 that wirelessly communicates with the circuit breaker 100.

When the user receives the prompt indicating that the mains power is restored from the circuit breaker 100, the alternating current output function of the energy storage device 300 can be manually disabled, and the switch 101 is manually turned on to restore mains power supply.

When the circuit breaker 100 and the energy storage device 300 are bound to the same mobile terminal 900 to establish the local area network, the user can also remotely disable the alternating current output function of the energy storage device 300 through the application on the mobile terminal 900, and then set, through the mobile terminal 900, the circuit breaker 100 to turn on the switch 101 or manually turn on switch 101, to restore mains power supply by.

In an example, if the circuit breaker 100 issues a voice prompt, the prompt may be: “Mains power is restored. Please disable the alternating current output function of the energy storage device before turning on the main switch!”

It should be understood that, if the alternating current output function of the energy storage device 300 is not disabled first to disconnect the electrical connection between the energy storage device 300 and the household load 400, the switch 101 is unable to be unlocked and turned on. Therefore, when the circuit breaker 100 of the present disclosure detects that the mains power is restored during the process in which the energy storage device 300 supplies power to the household load 400, it issues the prompt indicating that the mains power is restored, which can remind the user to promptly disable the alternating current output function of the energy storage device 300, unlocking and turning on the switch 101. Accordingly, normal operation of circuits inside the household power distribution network 10 is ensured.

In this way, in the present disclosure, during the process in which the energy storage device 300 supplies power to the household load 400, upon detecting that the mains power is restored, the circuit breaker 100 can issue the prompt indicating that the mains power is restored, which facilitates the user in promptly disabling the alternating current output function of the energy storage device 300, unlocking and turning on the switch 101. Accordingly, the normal operation of the circuits inside the household power distribution network 10 is ensured.

As illustrated in FIG. 20, in some embodiments, the circuit breaker 100 further includes the motor 1042. The control module 104 is connected to both the detection module 103 and the motor 1042. The motor 1042 is connected to the switch 101. The control module 104 is configured to: when the detection module 103 detects that the first terminal G1 is de-energized and the household load 400 is connected to the energy storage device 300, controls the motor 1042 to turn off the switch 101 and controls the energy storage device 300 to supply power to the household load 400.

When the mains power fails, the detection module 103 can control the motor 1042 to drive the switch 101 to be turned off upon detecting a mains power failure, disconnecting the household load 400 from the mains power and making the household load 400 an independent module. In this case, if the user has the energy storage device 300 in the household, the user can connect the energy storage device 300 to the household load 400 and enable the alternating current output function of the energy storage device 300. The energy storage device 300 can be connected to the household load 400 by plugging it into any wall socket 500 used in the household. That is, in the present disclosure, the alternating current from the energy storage device 300 can be supplied to the household load 400 through a wall socket 500 in any room of the household, supplying alternating current power to the entire household.

For example, as illustrated in FIG. 20, the energy storage device 300 may be connected to a wall socket 500 in the living room, or to a wall socket 500 in another room. In the present disclosure, a connection position of the energy storage device 300 can be determined based on user's convenience and maximum power of the energy storage device 300.

In this way, in the present disclosure, when the detection module 103 detects that the first terminal G1 is de-energized and the energy storage device 300 is connected to the household load 400, the motor 1042 can be controlled by the control module 104 to turn off the switch 101 and the energy storage device 300 can be controlled to supply power to the household load 400. That is, switching of the power supply source for the household load 400 can be realized by the circuit breaker 100 composed of the control module 104, the detection module 103, and the motor 1042.

As illustrated in FIG. 20, in some embodiments, the motor 1042 includes a mechanical drive unit 10421 and a mechanical locking unit 10422 connected to the mechanical drive unit 10421. Both the mechanical drive unit 10421 and the mechanical locking unit 10422 are connected to the control module 104. The control module 104 is further configured to control the mechanical drive unit 10421 to move to turn off the switch 101 when the first terminal G1 is de-energized, and to control the mechanical locking unit 10422 to lock the mechanical drive unit 10421 within a predetermined time period after the energy storage device 300 begins supplying power to the household load 400, so as to maintain the switch 101 in an off state.

Specifically, the mechanical drive unit 10421 may be a drive shaft. Correspondingly, the circuit breaker 100 further includes a drive shaft control circuit connected to the control module 104 and the drive shaft. When the mains power fails, the detection module 103, upon detecting the mains power failure, can control the drive shaft to rotate via the drive shaft control circuit. Therefore, the switch 101 is controlled to be turned off, disconnecting the household load 400 from the mains power and making the household load 400 an independent module.

The predetermined time period may be, for example, 0 seconds(s), 0.1 s, 0.2 s, 0.3 s, 0.4 s, 0.5 s, 0.6 s, 0.7 s, 0.8 s, or 1 s, which is not limited herein. When the predetermined time period is 0 s, the control module 104 can control the mechanical locking unit 10422 to lock the mechanical drive unit 10421 at the moment when the first terminal G1 is de-energized and the energy storage device 300 begins supplying power to the household load 400, to maintain the switch in the off state. When the predetermined time period is 0.1 s, the control module 104 can control the mechanical locking unit 10422 to lock the mechanical drive unit 10421 within 0.1 s after the mains power is de-energized and the energy storage device 300 begins supplying power to the household load 400, to maintain the switch 101 in the off state.

It should be understood that, when the mains power is de-energized and the energy storage device 300 supplies the alternating current power to the household load 400, either immediately or within the predetermined time period, the control module 104 controls the mechanical locking unit 10422 to lock the mechanical drive unit 10421. The mechanical drive unit 10421 can be locked at a rotational position corresponding to an off state of the switch 101, which prevents the user from accidentally actuating the switch 101 during the operation of the energy storage device 300 supplying power to the household load 400, which would otherwise connect the household load 400 to the mains power and cause the energy storage device 300 to malfunction and pose an electrical hazard.

Specifically, when the switch 101 is turned off and the energy storage device 300 supplies power to the household load 400, the detection module 103 can simultaneously collect the current values of the first terminal G1 and the second terminal G2. The control module 104 determines whether the first terminal G1 and the second terminal G2 are energized based on the current values.

If the detection module 103 samples a current value of 0 at the first terminal G1 and a non-zero or relatively large current value at the second terminal G2, the control module 104 can determine that the first terminal G1 is not energized, the mains power is still in a de-energized state, and the second terminal G2 is energized. Therefore, the control module 104 can control the mechanical locking unit 10422 to lock the mechanical drive unit 10421 to maintain the switch 101 in the off state, and record that the household power distribution network 10 is currently in an energy storage emergency standby power state.

If the detection module 103 samples a non-zero or relatively large current value at the first terminal G1 and the non-zero or relatively large current value at the second terminal G2, the control module 104 can determine that the first terminal G1 is energized, the mains power is restored, and the second terminal G2 is energized. Therefore, the control module 104 can control the mechanical locking unit 10422 to lock the mechanical drive unit 10421 to maintain the switch 101 in the off state and remind the user that the mains power is restored. This facilitates the user in promptly disabling the alternating current output function of the energy storage device 300 or disconnecting the energy storage device 300 from an energy storage connection terminal 30, and in turning off the switch 101 manually or through the application (APP) on the mobile terminal 900, restoring power supply from the mains power to the household load 400.

If the detection module 103 samples the non-zero or relatively large current value at the first terminal G1 and a current value of 0 at the second terminal G2, the control module 104 can determine that the first terminal G1 is energized, the mains power is restored, and the second terminal G2 is de-energized. This indicates that the energy storage device 300 has disabled its alternating current output function or has been disconnected from the energy storage access terminal 30, and has stopped supplying power to the household load 400. In this cast, the control module 104 can directly control the switch 101 to be turned on, restoring power supply from the mains power to the household load 400.

As illustrated in FIG. 20, the control module 104 is electrically connected to a first terminal of the detection module 103, a second terminal of the detection module 103 is electrically connected to the second terminal G2, and a third terminal of the detection module 103 is electrically connected to the first terminal G1. The detection module 103 is configured to collect electrical signals from the second terminal G2 and the first terminal G1. The control module 104 is configured to determine whether the first terminal G1 and the second terminal G2 are energized based on the electrical signals, and to control the mechanical locking unit 10422 to lock or unlock the mechanical drive unit 10421, or to control the switch 101 to be turned off or turned on.

Specifically, the detection module 103 can collect the electrical signals from the second terminal G2 and the first terminal G1, and transmit the sampled electrical signals to the control module 104. The control module 104 can determine whether a mains power input terminal is energized and whether the second terminal G2 is energized based on the electrical signals, and control the switch 101 to be turned off or turned on. The electrical signals may be current signals or voltage signals, which are not limited herein.

In detail, when the detection module 103 samples that a current value of the first terminal G1 is not 0 or is relatively large and the household load 400 is not connected to the energy storage device 300, the control module 104 can determine that the first terminal G1 is energized, that is, determine that the mains power is normal. In this case, the switch 101 can be controlled to be turned off, allowing the mains power to supply power to the household load 400.

When the detection module 103 samples that the current value of the first terminal G1 is 0 and the household load 400 is connected to the energy storage device 300, the control module 104 can determine that the first terminal G1 is not connected to the mains power, that is, the mains power is de-energized. In this case, the switch 101 can be controlled to be turned on, allowing the energy storage device 300 to supply power to the household load 400.

In other words, by providing the detection module 103, the circuit breaker 100 of the present disclosure can collect the electrical signals from the first terminal G1 and the second terminal G2 in real time, which allows the control module 104 to determine whether the mains power and the household load 400 are energized, and then performs corresponding intelligent control. This brings convenience to user's lives. In addition, it guarantees convenience and safety of the user in using the energy storage device 300 for household emergency power standby, thereby avoiding short circuits in the circuit formed by the energy storage device 300 and the mains power, and ensuring safety of the user in using the energy storage device 300 for emergency power supply.

In this way, the circuit breaker 100 of the present disclosure can control the mechanical locking unit 10422 to lock the mechanical drive unit 10421 through the control module 104 at a moment when the mains power fails and the energy storage device 300 supplies the alternating current power to the household load 400 or within the predetermined time period thereafter, which can prevent a circuit failure when the energy storage device 300 supplies power to the household load 400, ensuring circuit safety during power supply of the energy storage device 300.

In some embodiments, the present disclosure further provides a power distribution box 700, including the circuit breaker 100 in the above-described embodiments.

The power distribution box 700 is a metal or insulation plastic enclosure that integrates various electrical components. As a core component of the power distribution box 700, the circuit breaker 100 is responsible for controlling the connection and disconnection between the first alternating current source and the load, protecting the circuit from overload and short circuit damage. In addition to the circuit breaker 100, the power distribution box 700 further includes a wiring system connected to each load branch of the plurality of load branches and a disconnect switch 600. The power distribution box 700 facilitates energizing and de-energizing the entire household or a specific circuit. By scientifically and rationally, through the power distribution box 700, distributing the single incoming circuit mains power to a plurality of independent circuits in various areas of the household, zone-based and function-based power supply can be achieved.

In some embodiments, the present disclosure further provides a household power distribution network 10, including the power distribution box 700, the energy storage device 300, and the plurality of load branches.

As illustrated in FIG. 1, the household power distribution network 10 includes a first alternating current power supply 200, the power distribution box 700, and the plurality of load branches. These load branches include branches in which m household loads 400 that serve sorely as power-consuming devices are located and branches in which n energy storage devices 300 are located.

The energy storage device 300 is connected to a power supply branch via a power supply interface. The energy storage device 300 supplies power to the plurality of load branches through the power supply interface.

In some embodiments, the energy storage device 300 is connected to the load branches via a grid-connected/off-grid interface. The grid-connected/off-grid interface allows the energy storage device 300 to switch between a grid-connected mode and an off-grid mode. In the grid-connected mode, the energy storage device 300 is connected to the public power grid that supplies the mains power, can perform charging or discharging operations, and participates in grid demand response or ancillary services. In the off-grid mode, the energy storage device 300 is disconnected from the public power grid, to form an independent microgrid, which supplies power to critical loads on other local load branches, ensuring continuous operation of the critical loads.

The household loads 400 include air conditioners, refrigerators, washing machines, electric water heaters, televisions, lighting devices, office devices, and other power consumption appliances.

Through the circuit breaker 100 according to the embodiments of the present disclosure, the household power distribution network 10 can automatically switch to power supply by the energy storage device 300 when the first alternating current power supply 200 (such as the mains power) is de-energized, and automatically switch back to power supply by the mains power when the mains power is restored. In addition, the household power distribution network 10 controls the connection and disconnection of different loads through the power distribution box 700 and the wall socket 500, realizing power supply management for various areas or devices in the household power distribution network 10. Through a communication interface, communication with the energy storage device 300 and other smart devices is realized, supporting remote monitoring of an operation state of the household power distribution network 10 and remote control. The household power distribution network 10 can achieve intelligent power management and load control, improving flexibility and reliability of the household power consumption.

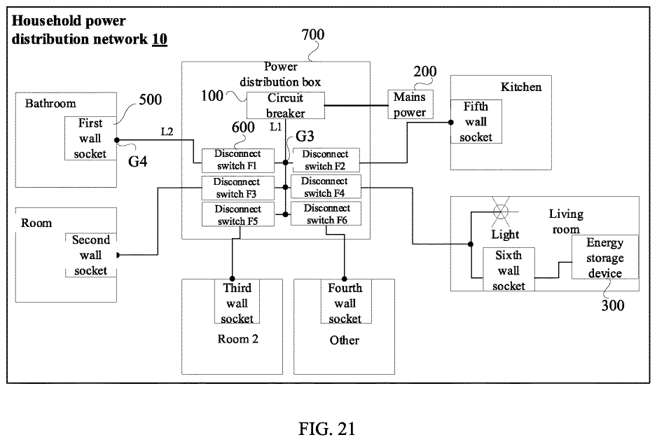

As illustrated in FIG. 21, in some embodiments, a main output line L1 directly output from the power distribution box 700 is branched into a plurality of output branches L2. The main output line is electrically connected to the plurality of output branches L2. The plurality of output branches L2 include an electric energy input terminal G3, a household load connection terminal G4, and a disconnect switch 600. The electric energy input terminal G3 is connected to the switch 101. The disconnect switch 600 is disposed between the electric energy input terminal G3 and the household load connection terminal G4 and configured to control a connection and disconnection of a path between the electric energy input terminal G3 and the household load connection terminal G4. The disconnect switch 600 may be a circuit breaker.

Specifically, as illustrated in FIG. 21, each of a bathroom, room 1, room 2, a living room, and a kitchen in a user's home is provided with a corresponding output branch L2. That is, the power distribution box 700 in each household area is correspondingly provided with a household load input terminal G4 electrically connected to the household loads 400 in different household areas. The power consumption of the household load 400 in each household area can be controlled by turning off or turning on the disconnect switch 600.

For example, when the disconnect switch 600 corresponding to the bathroom is turned on, the path between the electric energy input terminal G3 of the bathroom and the household load input terminal G4 is conducted, in such a manner that the household loads 400 in the bathroom, such as lights and heaters, can be connected to the alternating current power and operate normally. When the disconnect switch 600 corresponding to the bathroom is turned off, the path between the electric energy input terminal G3 of the bathroom and the household load input terminal G4 is disconnected. In this case, the household loads 400 in the bathroom, such as lights and heaters, cannot be connected to the alternating current power and stop operating.

For example, when the mains power is de-energized and the switch 101 is turned off, if the energy storage device 300 is connected to a sixth wall socket 500 in the living room, the alternating current output function of the energy storage device 300 may be enabled. In addition, the alternating current power of the energy storage device 300 may be connected to a wall socket 500 in any room of the household, with the connection position freely determined according to user convenience or power requirement, so as to supply the alternating current power of the energy storage device 300 to the household loads 400 and thereby to the entire household. The wall socket 500 may be a special wall socket 500 configured to be connected to the energy storage device 300 for power supply.

In addition, when the energy storage device 300 is connected to the second terminal G2 through the wall socket 500 in the household area to supply power to the household load 400, output power of the energy storage device 300 is determined by the maximum power of the energy storage device 300 used and the overcurrent capacities of the connected wall socket 500 and the disconnect switch 600 on the branch in which the wall socket 500 is located.

In this way, the power distribution box 700 of the present disclosure can control power consumption of loads in different household areas by providing the plurality of output branches L2.

In some embodiments, the circuit breaker 100 is further configured to adjust a receivable voltage range at the second terminal G2, to allow an output voltage of the energy storage device 300 to match an input voltage of the second terminal G2.

It should be understood that, since different countries have different requirements for household alternating current power, the output voltage of the energy storage device 300 also differs when used for emergency power supply. Therefore, the output voltage of the energy storage device 300 needs to be matched with the voltage used in the household, in such a manner that the energy storage device 300 operates normally and supplies power to the household load 400.

It should be noted that, in specific embodiments of the present disclosure, when the embodiments of the present disclosure are applied to specific products or technologies, the data related to user identity or characteristics involved needs to obtain the permission or consent of the user, and the collection, use, and processing of the related data need to comply with the relevant laws, regulations, and standards of the relevant countries and regions.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A circuit breaker for a household power distribution network, wherein the household power distribution network comprises a first alternating current power supply, an energy storage device, and a plurality of load branches, the plurality of load branches being connected in parallel, and at least one of the plurality of load branches being connected to the energy storage device, wherein the circuit breaker comprises:
a switch having a first terminal configured to be connected to the first alternating current power supply and a second terminal configured to be connected to the plurality of load branches;
a communication module configured to communicate with the energy storage device;
a detection module connected to the first terminal of the switch and configured to detect whether the first terminal of the switch is de-energized and to generate a first detection signal indicating whether the first alternating current power supply is de-energized; and
a control module connected to the detection module and the communication module, the control module being capable of controlling the switch to be turned on;
wherein when the first alternating current power supply is de-energized, the switch is turned off, and the control module is configured to transmit a first signal to the energy storage device via the communication module, to allow the energy storage device to supply a second alternating current power supply to other load branches of the plurality of load branches.

2. The circuit breaker according to claim 1, further comprising a standby power supply configured to supply power to the detection module, the communication module, and the control module when the first alternating current power supply is de-energized.

3. The circuit breaker according to claim 2, further comprising a power supply module, wherein the first alternating current power supply supplies power to the detection module, the communication module, and the control module through the power supply module.

4. The circuit breaker according to claim 2, wherein the standby power supply is connected to the first terminal and/or the second terminal of the switch, to be charged through the first alternating current power supply and/or the energy storage device.

5. The circuit breaker according to claim 3, wherein:
the standby power supply is connected between the first terminal of the switch and the power supply module; or
the standby power supply is connected to the power supply module.

6. The circuit breaker according to claim 3, wherein the standby power supply is connected to the power supply module, wherein the standby power supply supplies power to the communication module, the detection module, and the control module through the power supply module.

7. The circuit breaker according to claim 1, wherein the detection module is connected to the second terminal of the switch, the detection module being further configured to detect whether the second terminal of the switch is de-energized and to generate a second detection signal indicating whether the energy storage device is de-energized.

8. The circuit breaker according to claim 7, wherein the control module is further configured to control the switch to be turned on when determining, based on the first detection signal and the second detection signal, that the first alternating current power supply is energized and the energy storage power supply is de-energized.

9. The circuit breaker according to claim 1, further comprising an electrical connection port, wherein the electrical connection port is connected to an external power supply to allow the external power supply to supply power to the detection module, the communication module, and the control module.

10. The circuit breaker according to claim 9, further comprising a power supply module connected to the electrical connection port, wherein the external power supply supplies power to the communication module, the detection module, and the control module through the power supply module.

11. The circuit breaker according to claim 9, further comprising a standby power supply configured to supply power to the communication module, the detection module, and the control module when the first alternating current power supply is de-energized, wherein the standby power supply is connected to the external power supply via the electrical connection port for charging.

12. The circuit breaker according to claim 1, further comprising a power supply module connected to the first terminal and/or the second terminal of the switch, wherein the first alternating current power supply and/or the energy storage device supplies power to the communication module, the detection module, and the control module through the power supply module.

13. The circuit breaker according to claim 12, wherein:
the switch is a normally open switch; or
the control module is configured to control the switch to be turned off when determining, based on the first detection signal, that the first alternating current power supply is de-energized.

14. The circuit breaker according to claim 12, wherein the control module is further configured to transmit the first signal to the energy storage device via the communication module when the first alternating current power supply is de-energized and an electric quantity of the energy storage device is greater than a predetermined standby electric quantity, to allow the energy storage device to supply a second alternating current power supply to the other load branches of the plurality of load branches.

15. The circuit breaker according to claim 14, wherein the control module is further configured to, when the electric quantity of the energy storage device is less than or equal to the predetermined standby electric quantity, transmit a power supply stopping signal to the energy storage device via the communication module to allow the energy storage device to stop supplying the second alternating current power supply to the other load branches of the plurality of load branches, and to control the switch to be turned on.

16. The circuit breaker according to claim 12, wherein the control module is further configured to transmit a second signal to the energy storage device via the communication module when determining, based on the first detection signal, that the first alternating current power supply is energized, to allow the energy storage device to stop supplying power.

17. The circuit breaker according to claim 16, wherein the control module is further configured to control the switch to be turned on when the energy storage device stops supplying power.

18. The circuit breaker according to claim 12, wherein the control module comprises a controller and a motor, wherein the controller is configured to control operation of the motor, and the motor is capable of driving the switch to be turned on.

19. A power distribution box, comprising a circuit breaker for a household power distribution network, wherein the household power distribution network comprises a first alternating current power supply, an energy storage device, and a plurality of load branches, the plurality of load branches being connected in parallel, and at least one of the plurality of load branches being connected to the energy storage device, wherein the circuit breaker comprises:
a switch having a first terminal configured to be connected to the first alternating current power supply and a second terminal configured to be connected to the plurality of load branches;
a communication module configured to communicate with the energy storage device;
a detection module connected to the first terminal of the switch and configured to detect whether the first terminal of the switch is de-energized and to generate a first detection signal indicating whether the first alternating current power supply is de-energized; and
a control module connected to the detection module and the communication module and capable of controlling the switch to be turned on;
wherein when the first alternating current power supply is de-energized, the switch is turned off, and the control module is configured to transmit a first signal to the energy storage device via the communication module, to allow the energy storage device to supply a second alternating current power supply to other load branches of the plurality of load branches.

20. A household power distribution network, comprising:
a first alternating current power supply;
an energy storage device;
a plurality of load branches that are connected in parallel, at least one of the plurality of load branches being connected to the energy storage device; and
a circuit breaker, wherein the circuit breaker comprises:
a switch having a first terminal connected to the first alternating current power supply and a second terminal connected to the plurality of load branches;
a communication module configured to communicate with the energy storage device;
a detection module connected to the first terminal of the switch and configured to detect whether the first terminal of the switch is de-energized and to generate a first detection signal indicating whether the first alternating current power supply is de-energized; and
a control module connected to the detection module and the communication module and capable of controlling the switch to be turned on;
wherein when the first alternating current power supply is de-energized, the switch is turned off, and the control module is configured to transmit a first signal to the energy storage device via the communication module, to allow the energy storage device to supply a second alternating current power supply to other load branches of the plurality of load branches.
